(19) United States
(12) Patent Application Publication
(10) Pub. No.: US 2009/0323990 A1
(43) Pub. Date: Dec. 31, 2009

(54) SPEAKER

(76) Inventors: Hee Jin Kim, Daegu (KR); Young In Ko, Gyeongsangbuk-do (KR)

Correspondence Address: KED & ASSOCIATES, LLP, P.O. Box 221200, Chantilly, VA, 20153-1200, US

(21) Appl. No.: 12/304,477

(22) PCT Filed: Jan. 4, 2007
(86) PCT No.: PCT/KR2007/000049

§ 371 Date: Dec. 12, 2008

(30) Foreign Application Priority Data
Jun. 29, 2006 (KR) 1020060059205

(51) Int. Cl. H04R 1/00

(52) U.S. Cl. 381/191

(57) ABSTRACT

A speaker is disclosed. A speaker includes a fixing part (500) fixed to a base frame; a motion part moved with respect to the fixing part by an electromagnetic force; a vibration plate (200) that vibrates in communication with the motion part (400); and a supporting member (220) that supports the motion part to prevent the motion part from being distorted. Therefore, according to the present invention, a speaker capable of reproducing a high quality sound and high power with a slim design may be embodied.

### TECHNICAL FIELD

The present invention relates to a speaker, and more particularly, to a speaker adaptable to a display apparatus such as a TV and a computer monitor.

### BACKGROUND ART

Generally, a speaker converts electrical signals to vibration of a vibration plate and creates waves in the air to generate an acoustic wave. That is, a speaker is a kind of a conversion device which converts electrical signals to an acoustic energy. A speaker includes vibration parts such as a vibration plate, support parts such as a damper, magnetic parts such as a magnet. A speaker may be classified into various categories based on a vibration plate position, a vibration plate shape, a principle/method for converting electrical signals to acoustic waves or the like. Especially, a speaker adapted to a display apparatus such as TV or the like is usually a radiation type speaker having a vibration plate positioned in the air. In the radiation type speaker, electric currents corresponding to acoustic signals are flowing in a coil provided in a magnetic field formed by a magnet and then the coil vibrates based on the intensity of electric currents, which is a common principle of a speaker operation.

Recently, a large screen display apparatus has been used broadly due to development of a semiconductor technology. To present a beautiful and simple design of such a large screen display apparatus as a FPD (Flat Panel Display), a speaker has to be small and slim. If a speaker is small, inner parts such as a vibration part, magnet part and support part should be small, as well. However, if a speaker is minimized, functions of a speaker may deteriorate. This is due to deterioration of sound radiation efficiency caused by reduction of a vibration part, especially effective vibration area, flux density reduction caused by a magnetic part and so on. However, in spite of the small size of a speaker, a speaker for a large screen display apparatus is required to have the same or better function as or than a conventional speaker.

In a speaker adapted to a FPD, it is not relatively easy to adjust a width and thickness of the speaker, while it is relatively easy to adjust a width and thickness of the speaker. Thus, it is general to reduce the width/thickness and can increase the length, in order not to reduce a work vibration area. That is, a speaker having a rectangular or an oval shape with a short width and long length (hereinafter, a track type speaker) is used not to reduce a work vibration area. That is, the speaker for a FPD has a high ratio of a long diameter to a short diameter, that is, a high ratio of the length to the width of a speaker.

Referring to FIGS. 1 and 2, a conventional track type speaker will be described.

A speaker 3 includes an energy conversion part 40 and 50 that converts an electrical energy (an electrical signal) to a kinetic energy, and a vibration plate 20 that converts the kinetic energy generated at the energy conversion part 40 and 50 to an acoustic energy.

The energy conversion part 40 and 50 includes a fixing part 50 and a motion part 40 relatively moved with respect to the fixing part 50 by an electromagnetic force. The vibration plate 20 is connected to the motion part 40 to reproduce a sound by using the vibration of vibration plate 20.

More specifically, the fixing part 50 is provided at a predetermined portion of a base frame 70. The fixing part 50 includes a permanent magnet 56 Commonly, an upper plate 52 and a lower plate 54 are provided on an upper portion and lower portion of the permanent magnet 56, respectively to concentrate a magnetic flux generated at the permanent magnet 56 there between. The motion part 40 is generally called as a voice coil assembly, which includes a bobbin 42 having a cylindrical shape and a voice coil 44 wound around the bobbin 42. The vibration plate 20 is connected to the bobbin 42. A center cap 29 is provided on a center of the vibration plate 20. The numeral reference 34 is a gasket.

A lower portion of the bobbin 42 is elastically connected to the base frame 70 by a damper 60. The vibration plate 20 is connected to an upper portion of the bobbin 42 and an outer end of the vibration plate 20 is connected to the base frame 70 by an elastic support part 30 (hereinafter, an edge). The damper 60 and the edge 30 are kinds of the support parts, which supports the vibration parts including the voice coil 44, the bobbin 42 and the vibration plate 20 in their appropriate position to perform a vertical motion, in other words, a piston motion. Thus, the supporting parts including the damper 60 and the edge 30 20 affect reproduction of high power and high quality sound.

As mentioned above, the track type speaker 3 is shaped with a narrow width and a long length. The vibration plate 20 has a large ratio of a length to a width. However, the section of the bobbin 42 has a circular shape. Also, the shape of the damper 60 corresponds to the shape of the bobbin 42 and thus is circular, more specifically, annular. As shown in FIG. 3, the damper 60 elastically supporting the bobbin 42 has a ring shape and is repeatedly curved a predetermined distance in a circumferential direction from a hollow part 61. That is, the damper 60 has a plurality of wrinkle parts 61a in approximately concentric circle shape.

Referring to FIG. 2, an operation of the track type speaker will be described as follows.

Once electric currents are applied to the voice coil 44, an inductive force is generated at the coil within the magnetic field of the permanent magnet 56 Hence, the voice coil 44 moves vertically and the bobbin 42 connected to the voice coil 44 moves vertically. Accordingly, the vibration plate 20 coupled to the bobbin 42 also vertically moves in communication with the vertical motion of voice coil 44, which is an upward/downward piston motion. That is, the vibration plate 20 vibrates forwardly/backwardly in communication with the voice coil 44 and the bobbin 42 to vibrate air, such that acoustic waves may be generated. The sound applied to the voice coil 44 as an electrical signal is substantially reproduced by the vibration of the vibration plate 20 to radiate the sound outside of the speaker.

### DISCLOSURE OF INVENTION

### Technical Problem

The conventional track type speaker described above has following problems.

First, the conventional track type speaker has a problem that it is limited to enlarge its effective area due to its structure. Moreover, the width of the conventional track type speaker is reduced and thus the sizes of the voice coil and damper are also reduced. Thus, it is difficult for the conventional track type speaker to endure the inputted high voltage. As a result, it is difficult to achieve high quality sound and high power.

Next, according to the conventional track type speaker, the width of the vibration plate is smaller than the length of the vibration plate. Not the whole portion of the vibration plate, but the center of the vibration plate is supported by the damper. Thereby, there may be unbalanced vibration in a longitudinal direction. Also, the vibration plate may be unbalancedly supported by the voice coil and the damper. Accordingly, resonance of vibration may be generated which might distort the reproduced sound due to a non-linear motion of the vibration parts. Still further, there may be a strange sound or damage of the parts due to the mechanical friction.

### Technical Solution

An object of the present invention is to provide a speaker which can be slim with preventing sound reproduction deterioration

To achieve these objects and other advantages and in accordance with the purpose of the invention, as embodied and broadly described herein, a speaker comprises a fixing part fixed to a base frame; a motion part moved with respect to the fixing part by an electromagnetic force; a vibration plate that vibrates in communication with the motion part; and a supporting member that supports the motion part to prevent the motion part from being distorted. The vibration plate may be formed in a track shape and the shape of the motion part may be corresponding to the shape of the vibration plate.

The supporting member may be provided on the vibration plate. Also, the supporting member may be substantially plate-shaped and the supporting member may perpendicularly support a center of the motion part. Also, a groove may be formed on the fixing part for the supporting member to pass through.

A fastening part may be formed in a back portion of the vibration plate, a shape of the fastening part corresponding to the motion part and being fastened to the motion part. The fastening part may be provided at an edge of the vibration plate. Also, the present invention further includes a damper. One side of the damper is connected to a length part of the motion part and the other side of the damper is connected to the base frame.

In another aspect of the present invention, a speaker includes a fixing part fixed to a base frame; a motion part moved with respect to the fixing part by an electromagnetic force; a vibration plate that vibrates in communication with the motion part; and a damper, one side of the damper connected to a length part of the motion part and the other side of the damper connected to the base frame.

The damper may include a first member coupled to the motion part and a second member extended from the first member in a stepped way.

A groove to be inserted in the motion part may be provided on the first member and a projection to be inserted in the base frame may be provided a side of the second member.

### Advantageous Effects

A speaker according to the present invention has an advantageous effect that it is possible to present a high quality sound/high power, with a slim design.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a front view of a conventional track type speaker;

FIG. 2 is a sectional view of FIG. 1;

FIG. 3 is a plane view illustrating a damper of FIG. 1;

FIG. 4 is an exploded perspective view illustrating an embodiment of a track type speaker according to the present invention;

FIGS. 5 and 6 are perspective views illustrating a vibration plate of FIG. 4, more specifically FIG. 5 is a perspective view seen from an upper portion and FIG. 6 is a perspective view seen from a lower portion; and

FIG. 7 is a sectional view of FIG. 4.

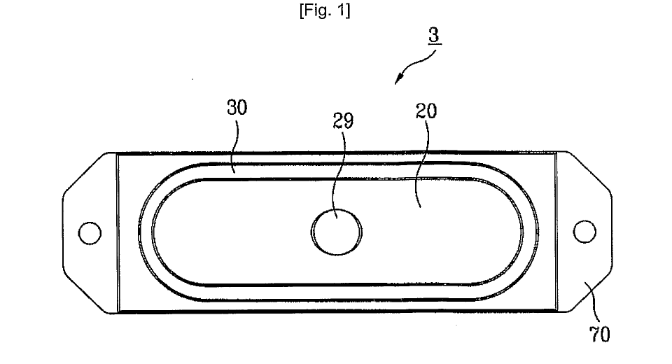

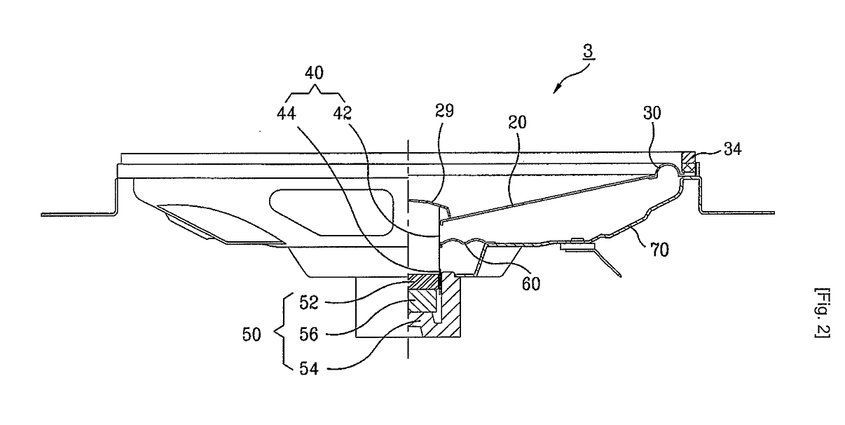

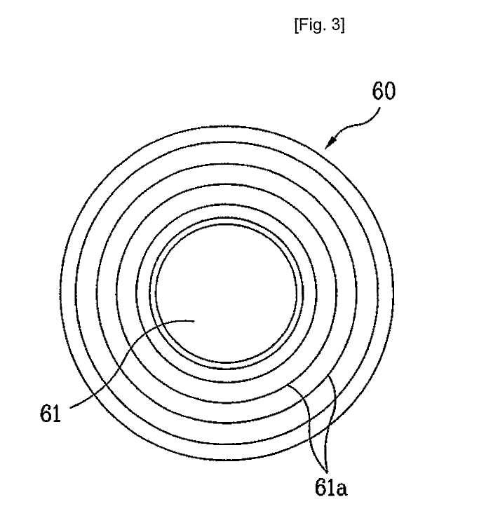

### BEST MODE FOR CARRYING OUT THE INVENTION

Reference will now be made in detail to the preferred embodiments of the present invention, examples of which are illustrated in the accompanying drawings.

Referring to FIG. 4, a preferred embodiment of a speaker according to the present invention will be described.

Similar to the prior art, the speaker according to the present invention includes an energy conversion part 400 and 500, and a vibration plate 200. The fixing part 500 includes a permanent magnet 560. Preferably, the fixing part 500 further includes an upper plate 520 and a lower plate 540. Also, an auxiliary magnet 550 may be provided in the fixing part 500 for concentrating the magnetic force. The lower plate 540 includes a mounting part 542 having an opened upper portion so that the auxiliary magnet 550, the upper plate 520 and the permanent magnet 560 are mounted on the mounting part 542.

The motion part 400 includes a bobbin 420 and a voice coil 440. The bobbin 420 is supported by a damper 600 and the vibration plate 200 is supported by an edge 300. According to the present invention, a supporting member 220 is further provided to prevent the motion part 400 from being distorted.

When the vibration plate 200 has a track shape, it is preferred that the motion part 400 also has a track shape. If a conventional circular shaped motion part such as a circular bobbin is provided in the track shaped vibration plate 200, the motion part 400 is connected to a center of the track shaped vibration plate 200, which may cause a resonance mode of the vibration plate 200. Thereby, in the track shaped vibration plate with the circular shaped motion part, an unintended vibration mode may occur and also a driving force for vibrating the vibration plate may decrease.

Meanwhile, if the motion part 400 is track shaped, a width part 420a of the motion part 400 could be distorted and then it is difficult to actually embody the track shaped motion part 400. The thickness of motion part 400, especially the thickness of the bobbin 420, is thin. Thereby, the width part 420a of the bobbin 420 may be distorted by the operation and inner heat of the speaker. Accordingly, the supporting member 220 is provided in the present invention to prevent the motion part 400 from being distorted. The position of supporting member 220 is not limited but it is preferred that the supporting member 220 is provided on the vibration plate 200.

The supporting member 220 will be described in detail.

The vibration plate 200 is provided in an upper portion of the bobbin 420 to vibrate in communication with the bobbin 420. The supporting member 220 is formed on the vibration plate 200 to prevent the bobbin 420 from being distorted. Thereby, since the supporting member 220 prevents the bobbin 420 from being distorted, the bobbin 420 may have a track shape and the size of bobbin 420 may be almost the same as that of the vibration plate 200, such that the driving force of the speaker may be enhanced greatly.

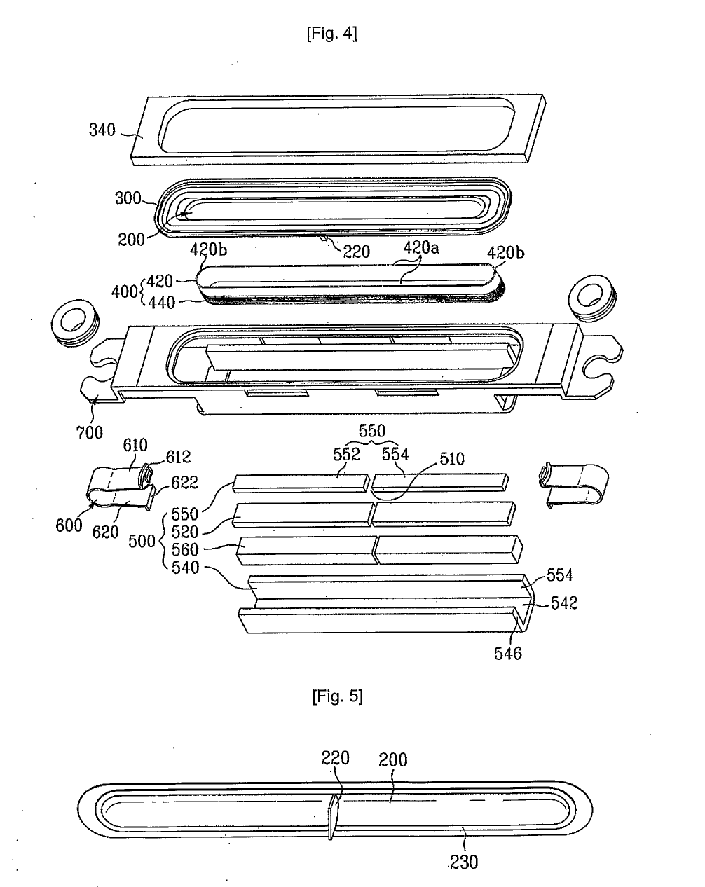

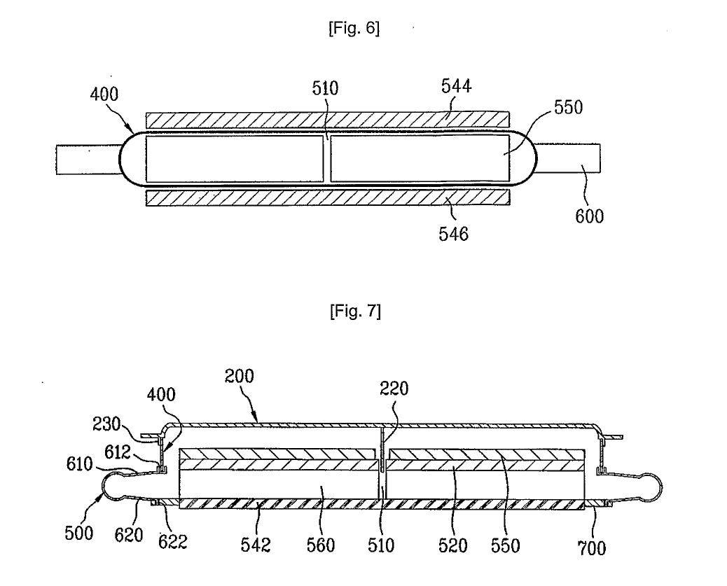

Referring to FIGS. 5 and 6, the vibration plate 200 will be described in detail.

The supporting member 220 and the fastening part 230 are provided in a back portion of the vibration plate 200. The supporting member 220 is fastened to the bobbin 420 to prevent the bobbin 420 from being distorted. The fastening part 230 is fastened to the bobbin 420 so that the fastening structure between the vibration plate 200 and the bobbin 420 is reinforced and work efficiency is enhanced, which will be described in detail later.

The supporting member 220 may be formed in various kinds of shapes if it performs its function of reinforcement to prevent the distortion of bobbin 420. It is preferred that the shape of the supporting member 220 is substantially plate-shaped to perpendicularly support the center of the bobbin 420. That is, the supporting member 220 may be positioned on a center the length part 420a. The reason why the supporting member 220 is fastened to the center of the bobbin 420 is that the center of length part 420a might have the biggest distortion, compared to the other portions. Although not shown in the drawings, a plurality of plate shaped supporting members 220 may be used.

Alternatively, a supporting member 220 configured to be separable from the vibration plate 200 may be installed at the bobbin 420. It is preferred that the supporting member 220 is provided on a badc surface of the vibration plate 200. That is because the supporting member 220 can be fabricated at the same time when the vibration plate 200 is injection molded. Thereby, the fabrication process is simple and efficient.

Since the supporting member 220 is perpendicular, a groove 510 corresponding to the supporting member 220 is provided on the fixing part 500, especially the auxiliary magnet 550, the upper plate 520 and the permanent magnet 560. The bobbin 420 vertically moves and accordingly the supporting member 220 fastened to the bobbin 420 vertically moves as well. Thus, the groove 510 should be provided on the fixing part 500 for the supporting member 220 vertically moving not to collide against the fixing part 500. Here, it is preferred that the auxiliary magnet 550 is divided into a pair of auxiliary magnets 552 and 554. Also, it is preferred that the upper plate 520 and the permanent magnet 560 are divided.

Referring to FIG. 7, the fastening structure between the bobbin 420 and the vibration plate 200 will be described.

The fastening part 230 is provided on a back surface of the vibration plate 200. It is preferred that an appearance of the fastening part 230 corresponds to an appearance of the bobbin 420, especially a sectional view of the bobbin 420. It is preferred that the fastening part 230 may be provided at an edge of the vibration plate 200. Alternatively, the fastening part 230 may be provided only a predetermine portion of the edge. For example, a plurality of small sized fastening parts may be provided each of which is spaced apart at a predetermined distance.

The fastening part 230 may be formed in an approximate rectangular or oval shape and downwardly projected. That facilitates the bobbin 420 to be fastened to an inner portion of the fastening part 230 easily. Although not shown in the drawings, the bobbin 420 may be fastened to an outer portion of the fastening part 230 and also the fastening part 230 may be a pair of vertical protrusions. Then, an upper portion of the bobbin 420 is insertedly fastened between the pair of vertical protrusions.

The shape of the vibration plate 200 may not be limited to the above embodiment and accordingly may be variable such as a plate type, cone type or the like. Although the track shaped vibration plate 200 and bobbin 420 are shown and described in the above embodiment, the present invention may not be limited thereto and accordingly may be adaptable in various ways. For example, in case of a speaker having a track shaped vibration plate/a circular bobbin or a circular vibration plate/a circular bobbin, an area enlargement part and a fastening part may be formed to enlarge an effective area of a vibration plate and to prevent distortion of a bobbin.

Next, referring to FIGS. 4 to 7, the fastening structure between the bobbin 420 and the damper 600 will be described.

When the track shaped vibration plate 200 and bobbin 420 are provided, there is little space in a width direction. Thus, according to the present invention, the damper 600 supports the vibration plate 200 only in a length part 420b (see FIG. 4). Distinguishably different from the prior art, the damper 600 of the present invention is connected only to the length part 420b of the bobbin 420. Preferably, the damper 600 is not plate shaped but curved or stepped (bent) in pairs.

More specifically, the damper 600 includes a first member 610 connected to an end of the length part 420b of the bobbin 420 and a second member 620 connected to the base frame 700. The first member 610 extends outwardly and the second member 620 extends inwardly from the first member 610. It is preferred that the second member 620 is stepped (bent) from the first member 610. This structure may enlarge the area of the damper 600, because the damper 600 of the present invention is mainly configured in a longitudinal (length) direction of the speaker, which has a spare space.

A groove 612 may be formed on a side of the first member 610, where the bobbin 420 is fastened, to insert a lower portion of the bobbin 420 therein. A projection 622 may be downwardly projected from a side of the second member 620 to be inserted in the base frame 700.

Referring to the FIG. 4, an operation of the speaker according to the present invention will be described.

Once an electrical signal is applied to the voice coil 440, the voice coil 440 vertically moves. In other words, the voice coil 440 performs a piston motion in interrelation with the permanent magnet 560. Hence, the bobbin 420 connected to the voice coil 440 also vertically performs a piston motion and the vibration plate 200 connected to the bobbin 420 vertically perform a piston motion to vibrate.

At that time, distortion of the bobbin 420 may be effectively prevented by the fastening part 230, such that strange sound generated by the distortion of the bobbin 420 may be prevented.

As described in the embodiment, it is preferred that the speaker of the present invention is adapted to a display apparatus such as a TV, a computer, a monitor or the like and it is not limited thereto. Alternatively, the speaker of the present invention may be adapted to other various kinds of apparatus.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The industrial applicability of the present invention is described in the disclosure of the invention.

First, there is an industrial applicability that a high quality sound/high power speaker can be presented.

Furthermore, since a nonlinear vertical motion of the vibration parts caused by a high ratio of the length to the width of the track type speaker may be reduced in present invention, there is another industrial applicability that a high sound quality speaker can be presented.

Still further, there is a further industrial applicability that a supporting structure of a damper may be improved.

1. A speaker comprising:
a fixing part fixed to a base frame;
a motion part moved with respect to the fixing part by an electromagnetic force;
a vibration plate that vibrates in communication with the motion part; and
a supporting member that supports the motion part to prevent the motion part from being distorted.

2. The speaker as clamed in claim 1, wherein the vibration plate is formed in a track shape.

3. The speaker as claimed in claim 2, wherein the shape of the motion part is corresponding to the shape of the vibration plate.

4. The speaker as claimed in claim 1, wherein the supporting member is provided on the vibration plate.

5. The speaker as claimed in claim 4, wherein the supporting member is substantially plate-shaped.

6. The speaker as claimed in claim 5, wherein the supporting member perpendicularly supports a center of the motion part.

7. The speaker as claimed in claim 4, wherein a groove is formed on the fixing part for the supporting member to pass through.

8. The speaker as claimed as claim 4, wherein a fastening part is formed in a back portion of the vibration plate, a shape of the fastening part corresponding to the motion part and being fastened to the motion part.

9. The speaker as claimed in claim 8, wherein the fastening part is provided at an edge of the vibration plate.

10. The speaker as claimed in claim 4, further comprising a damper, one side of the damper connected to a length part of the motion part and the other side of the damper connected to the base frame.

11. A speaker comprising:
a fixing part fixed to a base frame;
a motion part moved with respect to the fixing part by an electromagnetic force;
a vibration plate that vibrates in communication with the motion part; and
a damper, one side of the damper connected to a length part of the motion part and the other side of the damper connected to the base frame.

12. The speaker as claimed in claim 11, wherein the damper comprises a first member coupled to the motion part and a second member extended from the first member in a stepped way.

13. The speaker as claimed in claim 12, wherein a groove to be inserted in the motion part is provided on the first member and a projection to be inserted in the base frame may be provided on a side of the second member.
